(19) United States
(12) Patent Application Publication
(10) Pub. No.: US 2014/0279056 A1
(43) Pub. Date: Sep. 18, 2014

(54) INTELLIGENT PLATFORM FOR REAL-TIME BIDDING

(71) Applicant: TriVu Media, Inc., Longmeadow, MA (US)

(72) Inventors: Michael SULLIVAN, San Francisco, CA (US); Paul CALENTO, Longmeadow, MA (US); Miles DENNISON, Pelham, NY (US)

(73) Assignee: TriVu Media, Inc., Longmeadow, MA (US)

(21) Appl. No.: 14/218,807

(22) Filed: Mar. 18, 2014

Related U.S. Application Data
(60) Provisional application No. 61/791,551, filed on Mar. 15, 2013.

(51) Int. Cl. G06Q 30/02; G06F 17/30

(52) U.S. Cl. CPC G06Q 30/0275; G06F 17/30864
USPC 705/14.71; 707/709

(57) ABSTRACT

An intelligent platform for real-time bidding (RTB) includes a bidder that allows for the association of additional private or proprietary information with each bid it receives, and allows advertisers to filter impressions based on a rich set of attributes. The bidder can be used to bid across many ad exchanges using the same augmented bidding criteria. The system can have crawlers that include virtual web browser rendering for analysis to allow the system to determine location on a page, a size of the video, how it is played, and information about content in the video. The crawlers can include a browser-specific rendering crawler, which can determine browser-specific behavior.

### BACKGROUND

This application claims priority under §119(e) to U.S. Provisional Application No. 61/791,551, entitled “Video Intelligence Platform,” filed Mar. 15, 2013; the contents of which is incorporated by reference herein in its entirety and for all purposes.

Real time bidding (RTB) relates to the ability of advertisers to bid on content to be inserted on websites and in online videos in real time on an impression by impression basis. While a webpage is loading, or a video is starting, an online bidding process can be taking place in the background to determine which entity will provide advertising content to the user. At this speed, the bidding auction is performed by programmed computers based on programmed guidelines. Systems for purchasing digital advertising use “bidders” which are servers that are programmed to act on behalf one or more advertisers and respond to requests for bids from an RTB exchange. Bidders are responsible for evaluating the attributes of a bid request and deciding whether or not to place a bid for the ad impression, what price to bid for the ad impression, and what ad(s) should be shown for a particular impression if the winning bid is placed.

Bidders operate under a peculiar set of technical conditions concerning the large amount of bid traffic they must handle and the low latency typically required by Ad Exchanges. Recent development in bidders have been focused on user and audience tracking and targeting, and other methods that allow decisions to be made for an impression using attributes provided by the exchange (or a simple fixed, static mapping of attributes to standardized names and values), and allowing the advertiser to filter impressions to bid against based on this information.

RTB is based on the interaction of several different computer systems operating separately in a coordinated fashion with each other and the web browser or media device of a user. FIG. 1 shows the typical interaction of these systems and how they work together to display an advertisement to a user.
1. A user's browser, television, or other media device requests a web page, video, or app from a publisher's server.
2. The publisher's server returns page or other content with an Ad Tag provided to the publisher by the Ad Exchange for the purpose of selling an ad impression on the exchange. The Ad Tag contains instructions that direct the user's device to request and display an ad from the Ad Exchange.
3. The Ad Tag is loaded and/or executed in the user's device. The Ad Tag collects information about the device, the user, the user's location, and surrounding content and context (e.g., URL and location on page) of where the advertisement(s) will be placed sends the collected data to the exchange along with the request for one or more advertisements.
4. The exchange compiles, processes and logs all of the information collected from the Ad Tag, packages it in a standard format, decides (pre-filters) which bidders it should request a bid from, and sends the selected bidders a bid request.
5. The bidder evaluates the request and either places a bid (bid response), ignores the request, or otherwise indicates to the exchange that it declines to bid. In the bid response, the bidder typically discloses one or more bids on behalf of one or more advertisers for one or more advertisements included in the bid request. Along with the bids, the bidder includes Ad Tag(s) (one per bid) to be executed on the user's device in the case of a winning bid. There is typically a strict time limit (e.g., 100 ms) for responding to a bid request so that the auction can remain transparent to the user.
6. The exchange collects bid responses from bidders and selects the winning Ad Tag to be served for each ad included in the bid request according to its proprietary auction-like decisioning algorithms. The Ad Tags supplied by the winning bidder are modified by the exchange to include the winning price of the ad impression(s) in the request to the Ad Server. The exchange responds to the original request made by the Ad Tag on the user's device (which is still awaiting a response) with the advertisements decided by the real-time auction. A cookie is placed on the device by the exchange in its response to uniquely identify the user across impressions.
7. The user's device places the additional Ad Tags in the appropriate place on the media property, and executes the Ad Tags, thereby requesting the ads from their respective Ad Servers.
8. The Ad Server may send a message to the bidder or otherwise communication about the ad impressions, typically including the bid request identifier of the winning bid along with the price paid for the impression (which may be different than the bid price, for example if a second-price auction selection mechanism is used to determine a winning bid). The bidder will then, at a minimum, log the winning bid price and adjust its working budget to account for the price for the ad impression.
   Alternatively, as indicated by Step 8.1 the user's device may communicate this information back to the bidder directly (as determined by the Ad Tag(s) returned by the exchange). This is sometimes preferable that having this information passed back to the bidder via the Ad Server.
9. The Ad Server returns the advertisement and associated information used by the User's Device to display the advertisement. The Ad Server may return scripts or additional Ad Tags to control the user's experience with the advertisement, especially with regard to the user's interaction with the advertisement and publisher's web page via his device.
   The content returned by the Ad Server may cause the User's Device to send messages back to the Ad Server via the use of tracking pixels or similar means to alert the Ad Server about the user's interaction with the advertisement (see Step 9.1). For example, if the User clicks on an advertisement, or in the case of a video advertisement, that the User has watched the entirety or some portion of the advertisement.
10. Typically, if the User clicks on an advertisement, their device is directed to navigate away from the Publisher's web page to a URL provided by the Ad Server (and specified by the advertiser). This page is called the “Landing Page” for the advertisement, and may contain tracking pixels or ad tags to communicate messages back to the Ad Server about the user's interaction with the landing page (i.e., if a purchase was completed on the landing page, if the landing page properly loaded, if the user navigated off of the landing page to another page on the advertisers site, etc). These messages are sent via tracking pixel or ad tag requests to the ad server that are initiated by the landing page.
11. The Ad Server will receive additional notifications and alerts from the user's device informing the server of the user's interaction with the ad, for example when the user clicks the ad and is directed to the advertiser's Landing Page. The Ad Server or or device may additionally pass this information to the Bidder either in real-time or as part of an offline synchronization operation.

Referring to FIG. 2, A typical bidding system, or bidder, includes:
Bidder Endpoint Servers: reverse proxy server, typically HTTP, load-balanced over multiple machines proxying Bid Requests and responses to upstream bid servers according to HTTP proxying conventions.
RTB Targeting Database: a database that contains Ad Tags, advertiser-defined filters for identifying ad impressions on which to bid, along with bidding instructions such as maximum bid and relative bid adjustments for different filters.
Upstream Bid Servers: custom, modified, and/or proprietary servers (typically HTTP) that receive Bid Requests from Bidder Endpoint Servers, and evaluate one or more filters in the ad targeting database against the attributes of the Bid Requests. Each filter is associated with one or more Ad Tags, along with business rules for rotating or otherwise deciding which Ad Tag to submit at a given time to a Bid Request that matches its filter.
Ad Servers: each Ad Tag, when executed on a user's device, makes a request to an Ad Server (typically an HTTP endpoint) that actually returns the creative asset that is rendered as the advertisement. The Ad Tag may do arbitrary calculations on the user's device that determine various pieces of information about the device, the user, the users location, the application rendering the media, etc. This information is passed to the Ad Server and can be used to selectively serve the most appropriate ad/creative format. The Ad Server may also be notified with various information by the user's device, such as when the user clicks the ad, when the ad displays, or in the case of video advertisements, when the user watches various portions of the video ad, or in the case of rich media advertising and display advertising, when the ad is actually rendered on the screen or comes into view, or when the user otherwise interacts with the ad.
Ad Targeting and Reporting Console: a web page or application where advertisers or their agents and affiliates can create or edit filters in the database, associate filters with Ad Tags, and set or adjust budget and bidding parameters. Reporting/Logging Database: database where logs from Upstream Bid Servers and Ad Servers are stored, linking the data for a particular impression (or set of impressions) back to a specific advertiser/filter from the RTB Targeting Database.
Maintenance/Reporting Servers: collect and process the log files from the Ad Servers and Upstream Bid Servers and dump data into Reporting Database(s) in a scheduled fashion (usually once per hour, day, etc.). These servers may also respond to requests from advertisers for custom or scheduled reports via the Ad Targeting Console.

### SUMMARY

An intelligent bidding platform can be used to build and maintain a third party (not owned/operated by an Ad Exchange) inventory index that classifies the web pages, apps, and videos that are available for advertising on the exchange in a way that is tailored for an advertiser, as well as maintain statistics about the relative traffic rates, ad formats typically available, and information about the content, context and overall appearance of ads shown on different web pages, URLs or media properties.

Using such a system, an advertiser can target ad campaigns to custom content topics and media properties. If a video relates to its custom-defined topic, then a bid can be placed and the advertiser's ad will be directed to run against that video. For example, a person looks up a video called “how to change oil” can get a video ad for a tire store, or perhaps a banner ad within the video for a brand of oil. In prior bidding systems, the ad would be placed solely based on the domain of the web page, or a general topic classification made by the exchange or publisher (e.g., “Automotive” for the preceding oil change example), or based on the observed behavior of a particular list of users on the exchange based on previous media properties the users have visited as determined by browser cookies.

The intelligent platform for Real-Time Bidding includes a highly distributed, scalable, fault tolerant bidder that can handle bid request traffic from multiple Ad Exchanges, is easily deployable across ad exchange trading locations, and extendable by advertisers through the incorporation of arbitrary third party data into the bid decision process of the Bidder. Additionally it is fully deployable using virtual hardware provided by cloud-computing services such as Amazon Web Services or Google Cloud Computing.

The architecture and design of this Bidder platform are simpler than prior systems. Further, it leverages this design by utilizing algorithms to add a step to the Bidder Endpoint Server, where the Bid Request supplied by the Ad Exchange is parsed, augmented, and re-written in a distinct format. This allows attributes to be available for filter matching by advertisers to include additional attributes defined by the advertiser or other third party data sources, and standardized Ad Exchange-supplied attributes through configurable mappings and advertiser-defined tagging rules. This system can eliminate the need for maintenance servers and standalone Ad Servers, and can unify the reporting and ad targeting databases into same “virtual” database, enable real-time reporting for console, and allowing real-time visibility of third-party data to the Bidder. Upstream bid servers can be eliminated by directly converting Bid Requests into efficient hash-based database queries. Callouts to upstream bid serves by endpoint proxy servers can be replaced by single database lookup.

A potentially large list of attributes and values can be stored and indexed based on content-aware hash, allowing arbitrary Bid Request attributes to be matched against an almost limitless list of attribute/value pairs and combinations in almost constant time, all within the low-latency, high-traffic environment of an ad exchange bidder.

The systems here also includes the use of an Intelligent Bidding Platform to power a third party content indexing system. Such a system monitors URLs and partial URLs disclosed in the Bid Requests received by the bidder to maintain an index of content available for advertising on the exchange empirically, as opposed to relying on information provided by the exchange for ad inventory forecasting.

By using such a system, a third party bidder on the exchange (i.e., not the exchange itself, which is able to modify and canonize the information provided in the bid requests) can build, own, and maintain its own proprietary, empirically determined, cost-effective index of exchange traded ad inventory and targeting strategies. Moreover, it can do this without explicitly disclosing critical elements of the targeting strategy to the Ad Exchange. The third party content indexing system extends the intelligent bidding platform with an automated web crawling system that can monitor the content of URLs traded on the exchange by monitoring the exchange, and develop and design custom content classification rules that attach custom attributes to URLs or partial URLs.

The crawling system can be operated offline (i.e., the crawler operates independently from the bidder), but is integrated with the bidder through the platform via a shared real-time, transactional database system called the “index” that is queried directly by the bidder and replaces the upstream ad servers in this system.

The crawlers can include web browser rendering for analysis purposes either to a screen or to memory for analyzing the online content, such as a video, as if it were being played to a user to obtain additional information about the content. For videos, this rendering capability can determine location on a page, a size of the video, how it is played, and information about content in the video. The crawlers can include a browser-specific rendering crawler, which can determine browser-specific behavior. This is useful to determine compatibility, but also to determine how the video will appear on a mobile device versus a desktop browser.

This additional information can be used by customers to make better informed decisions about their advertising opportunities. If such information is provided to content providers, it can be used to obtain a better price for the content.

Other features and advantages will become apparent form the following description, drawings, and claims.

### BRIEF DESCRIPTION OF THE DRAWINGS

FIG. 1 is a flow diagram of a prior RTB bidding process.

FIG. 2 is a block diagram of a typical known bidding system.

FIGS. 3 and 4 are block diagrams illustrating a system according to embodiments described herein.

FIG. 5 is a block diagram of a directory server and connections thereto.

### DESCRIPTION

The inventors have observed that known bidders such as the one described above, operate under operating conditions that are atypical of a traditional web server. Differences between the operating conditions of a bidder and a typical web server include the following:
The number of Bid Requests that must be handled is very large. There are currently a limited number of Ad Exchanges, but they handle up to 80% of display and video advertising across the Internet according to some estimates. If a bidder were to receive all possible requests from all possible exchanges (a conceivable demand, considering there are currently only a handful of Ad Exchanges), there would be a request made to the bidder for 80% of all web pages served across the Internet that show ads. Even with basic pre-filtering configured with an exchange, Google's AdX can make over 500,000 Bid Requests per second to a bidder per trading location (assuming there are six trading locations around the globe).
The vast majority of Bid Requests may not merit a bid, so most requests to typical bidders are ignored or discarded. Logging these requests as text or some other intermediate format on the proxy servers generates a large amount of data that is then processed by maintenance servers to be useful. This logging can get operationally out of hand, and so non-matching Bid Requests are often discarded or poorly indexed.
There is typically a strict drop-dead time limit to respond to a request (e.g., 100 ms), which includes the roundtrip transport time of the request and response. This typically allows enough time for the upstream bid server to check the filters against the exchange-provided attributes in the request and possibly check certain attributes (such as user id, partial URL, city, zip code, etc.) against potentially large explicit lists of indexed values stored in the ad targeting database. Multiple or complex queries to a typical relational database (especially if done in a serial fashion) would likely require too much time for individual bid requests, making the data structures, indexing and database search strategies very important aspects of any Bidder.

As a result of these operating conditions, and the typical architecture of a bidder as described above, there are limitations to the current bidding systems commercially available. For example, options available to advertisers for building filters is limited to pre-defined building blocks that are based on the information available in the Bid Request and is supplied by the Ad Exchange, and. other attributes that are directly observable or easily available to the upstream Bidder at the time it evaluates a Bid Request (such as time-of-day, advertiser's available budget, etc). Current commercially available bidders usually are capable of selectively targeting collections of individual users identified by their user id supplied by the exchange. These bidders can map unique exchange user IDs to advertiser, defined lists of users stored in the ad targeting database. This is accomplished via a process known as cookie matching, and is often provided as a service by an ad exchange (hosted cookie matching).

Current commercially available bidders can selectively target or exclude large lists of URLs and/or partial URLs such as domain names. These bidders are able to match the URL or partial URL supplied to the bidder in the Bid Request against (potentially large) lists of URLs or partial URLs stored in the ad database. Most commercially available bidders are only able to selectively target or exclude domain names (not individual URLs), and others have limits on the size of the lists that are selectively targeted or excluded (e.g., on the order of 20,000). Current commercially available bidders can selectively target or exclude large lists of geolocations (such as cities, zip codes, congressional districts, states, counties, countries, etc.). These bidders are able to match the geolocation supplied by the ad exchange against a potentially large list of geolocations supplied by the advertiser.

Outside of list matching for specific users identified via cookie matching, URL whitelisting and blacklisting, and geotarging, current bidders lack the ability to incorporate custom Bid Request evaluation or classification rules into the bid decision-making process. The typical architecture of a bidder as described above is able to handle a small number of unique id lookups matching unique values to lists stored in the ad targeting database by pre-computing tables of user ids, geolocations, and URLs to list ids, and then allowing advertisers to include these list ids into their filters in various forms.

Existing Bidders can target ad impressions based solely on attributes provided by the Ad Exchange. Advertisers can create filters for targeting impressions on the exchange by explicitly providing the list of acceptable values for each attribute in a bid request. This list of acceptable values can also be marked as a “negative targeting list”, indicating to the bidder that all possible values for an attribute should pass the filter, with the exception of attributes listed. If an advertiser does not wish to filter impressions based on particular attributes, it provides no list of acceptable values for that attribute causing the Bidder to ignore that attribute when filtering Bid Requests (therefore allowing all possible values of that attribute to pass through the filter). For example, the Ad Exchange typically provides a User ID attribute, a User Location attribute, and a URL attribute in every Bid Request it sends the Bidder. Current bidders allow advertisers to specify an explicit list of URLs or partial URLs to target or exclude, an explicit list of User IDs to target or exclude, or an explicit list of User Locations to target or exclude.

For User targeting, a technique called “cookie matching” allows User ID lists to be built and maintained by the advertiser in the Bidder's system in an automated way based on an advertiser's website traffic. The Bidder (or company operating the Bidder) can make it easier for advertisers to accomplish common targeting objectives by maintaining frequently used URL, User ID, User Location, or other lists for advertisers to use rather than supplying their own. For example, a so-called blacklist of URLs may be maintained by the Bidder of all URLs or partial URLs that are suspected to contain pornography or other objectionable content. Advertisers may use this Bidder-supplied blacklist to avoid running on URLs commonly considered to be bad.

Referring to FIG. 4, an intelligent platform for real-time bidding replaces the typical bidder used in an RTB auction (referring to “Bidder” in FIG. 1). It includes a Real-time Data Index (RDI), which is a cluster of servers, running an LDAP or similar Directory Server and which acts as a switchboard that routes queries, data, signals and configuration information to and from a variety of different databases both internal and/or external to the platform.

The system includes an Exchange Bidder and Logger (EBL), which uses a Real-time Data Index to give the bidder access to various databases that can be used to make decisions about Bid Requests in real-time and/or control the behavior of the bidder. The EBL uses the RDI to buffer and dump data directly from Bidder servers across multiple distributed databases, rather than requiring a maintenance server like a typical bidder does to aggregate text logs from various machines, process, reformat and store reporting or performance data. Having access to the RDI for the association of additional, private, or proprietary information with each bid it receives, and allows advertisers to filter impressions based on attributes an Ad Exchange (also “exchange”); and calculates and standardizes certain missing or anomalous attributes across multiple exchanges so that the same Bidder can be used to bid across many Ad Exchanges using the same augmented bidding criteria.

FIG. 5 shows a directory server that can interact with local cache and local config databases, a distributed cluster database, a third party co-located database, and a distributed cluster cache database. This demonstrates the flexibility in querying local and remote third party databases in a system that can access in the time it takes to make a bid, e.g., 100 msec or less.

The systems and methods described here extend the capability of the Bidder to infer additional attributes (or modify exchange-supplied attributes) of a Bid Request based on (1) inference rules stored in a database, (2) predicates and data stored in a database within the bidder system or third party or remote systems, and (3) the exchange-supplied attributes of the Bid Request on which the inference rules are initially evaluated. An advertiser does not need to explicitly create or maintain (potentially unmanageably large) lists of URLs, User IDs or User Locations in order to build their own custom filters, and Bidders can provide more flexible targeting to advertisers by allowing them to edit/specify/change inference rules to customize targeting behavior

In the systems and methods described here, a data platform includes a high-volume bid server for real-time bidding (RTB) and programmatic advertising buying. The system is focused on content-based targeting for online video, and can handle real-time URL-level bidding and targeting across multiple exchanges. The system can crawl, classify, and index content of exchange-traded web pages and videos, and can incorporate external and third party APIs and data sources when available and properly configured. It can be implemented in a distributed cluster architecture running on virtual hardware, and is architected and designed for turnkey global deployment and synchronization using cloud-based data storage, leveraging capacity on demand, and able to scale to petabyte-level databases through the use of a distributed computing and data architecture.

Referring to FIG. 3, another representation of the system shows three main modules: a fire hose bidder and logger (FBL), an index, and a rendering crawler (RC). The system interacts with inventory sources, which are entities that have content inventory available for advertising. Customers include various entities that seek to provide advertising content, various entities that operate ad-exchange bidding technology on their behalf, and related entities that have various similar commercial uses for the system.

The index is a high-availability, low-latency, distributed, cluster-based directory server and database and API. It can process, sort and store of terabytes of data per machine, as well as act as a real-time “switchboard” to external data sources, allowing arbitrary data to be cached/indexed in an opaque manner for real-time access by the bidder. The index can store information about web page, videos, and other online content, along with metadata about the online content. The index can store (a) URL/video traffic data collected by the bidder/logger; and (b) crawl data collected by the rendering crawler (RC). Information that can be collected includes uniform resource locator (URL), channel and domain inventory levels, video player position, video player size, required user engagement to view a video and/or video ad, video title and abstract information, number of advertising positions available (within video and on the page), length of video, page text, and other contextual elements. The system can maintain algorithms that prioritize what video information gets collected and how often pages are crawled.

The fire hose bidder and logger is a high-throughput bidder and ad server built on top of the index. It can handle tens of thousands of simultaneous connections per machine in a cluster. It implements basic exchange bidding and ad serving functionality, provides real-time access to the index (suitable for production use by third party bidders), and logs exchange and ad traffic to the index in real-time to power fine grained reporting and monitoring. It monitors available inventory of videos (or other content to which ads can be inserted) by URL and acts as a central conduit for identifying relevant video advertising opportunities. It is source agnostic. The FBL connects with customers, such as advertising exchanges, DSP feeds, publishers, and other sources.

The rendering crawler is an off-line data collection and scraping system built on top of the index. It functions as a web spider that visits specific URLs, collects information about the page and auto-launches objects (Flash and other items) to collect additional information. Pages and videos can be “rendered” similar to how an actual user will interact with the video. The RC also fetches and integrates useful third party data related to the URL or videos on the page, consolidating the information into a single URL-keyed record. This can be done by, for example, using a plug-in to a browser, such as Mozilla browser. This rendering allows the system to collect information that would not be apparent from the “black box” placeholder where a video would be shown in a website. For example, the actual size of the video might be different from the size of the box. Also, how the video starts (auto-play or click-to-start) might not be apparent just from the box. Further, rendering can be used to identify content that an advertiser deems desirable or undesirable.

More specifically, the crawler functionality includes a hierarchy of crawlers with different capabilities, but that share a common database, index, and job queue so they work together. The different crawlers can be faster with less functionality and less overhead (cost), or slower but more comprehensive and more expensive.

The plaintext crawler is the fastest with a lower functionality. It pulls the content of an arbitrary URL, identifies the format of the data (HTML, JSON, text, etc.), parses the content, and stores the data about the content in the index. Content handlers are registered with the crawler to match based on URL and type of content. As the crawler visits URLs, it hands off the parsed and loaded content to any content handler that matches the URL/Data Format (i.e., any HTML from [//youtube.com/watch*]) so the system can perform custom parsing/data extraction. This crawler provides good speed and value for the work needed, especially for static content, APIs, feeds, etc. It also works well in checking whether URLs exist, mining for links, pulling text from a page, and checking if a page changed.

A JavaScript crawler is provided for HTML pages. This crawler can parse and load the page in a virtual web browser for analysis purposes using a plug-in to a browser. With the web browser, the crawler can download all the images, pixels, and script files, and run the JavaScript from the page to create the full DOM object of the page. This crawler is more expensive because it downloads more information per page and needs to wait for all of the content to load before it can index the page. Because it uses a virtual browser, it does not actually render the page such that it gets screenshots, flash content, or gets accurate numbers for where the different HTML elements show up on the page (above or below the fold, etc.).

A “headless rendering” crawler is used to get screenshots, flash content, and confident locations of elements on the page. It uses a more full-featured virtual browser that is referenced as a “headless” browser because it renders the page to memory rather than to a screen. With the headless rendering crawler, the page is fully loaded and fully rendered to memory so that all the layout and plugin content works. Additionally, since it a live browser, it can interact with pages, e.g., via scripts, while they are loaded to test the page.

A browser-specific rendering crawler can determine browser-specific content or behavior of a page. For example, if one loads a page in a mobile browser versus a desktop browser, the content might be different for the two browsers. Also, web pages can have errors on one browser or not another, and ad tags and targeting can change their behavior based on the browser. In order to crawl mobile pages, test web pages for browser-specific behavior, or to get browser-specific screenshots, this crawler is desirable. It works by creating a virtual screen. These crawlers can be used in a pipeline. The plaintext crawler grabs the URL first, does some basic indexing, and submits the content to the JavaScript crawler if necessary. If there is an error with the URL, it can be logged and discarded. The JavaScript crawler then provides the content from the fully loaded page, and is passed to the headless rendering crawler if screenshots are needed, or if there is flash or other video content on the page. The browser-specific crawler is used separately if there is a need to scan mobile content or for testing ad tags.

The data from the crawls is provided back into the index, which is where the logic goes into assigning tags to pages. For YouTube, for example, the system scrapes the official classifications directly from the crawl data. For other content, the classification is keyword based, and the system maps all of the classifications/tags to Freebase topic ids.

The tags and attributes assigned to URLs and partial URLs by the crawler are made available to the bidder for targeting (and to the advertiser for building filters) by augmenting Bid Requests that match the URL or partial URL with additional attributes that are identified by the classification rule the Crawler used to assign the attribute to the URL or partial URL. For example, assume an advertiser has an advertisement that is predominantly the color pink, and wishes to only show that ad on pages that are also predominantly pink. That advertiser could create a crawler rule that matches web pages that are mostly pink. This crawler rule could be implemented in JavaScript and uses a headless rendering crawler to assign the tag “MostlyPink” to the attribute “URLColor” on any URL where the rule matches.

When the bidder augments a Bid Request that has a URL that the crawler identified as matching this rule, the Bid Request will have a URLColor attribute set to MostlyPink. If an advertiser built a filter that requires the URLColor attribute matches MostlyPink, they will only place bids on Bid Requests that have been visited by the crawler and have been determined to be pink according to the advertiser's own rule.

Current bidding systems do not have the capability to perform this level of custom data management and targeting, or the ability to seamlessly incorporate newly defined data sources directly into the bidding system and be able to use this third party data for RTB.

The system can include three components as shown above, and is designed to create a pre-bid database used for actionable video and mobile advertising buying. This functionality, and particularly the use of the browser plug-ins, whether rendered to a screen or to memory, goes beyond what is often done. For example, some customers looking to provide advertising may be limited to information about the size of a black box where a video will be played. As noted above, by rendering the video, the customer can know how large the video actually is (as opposed to the size of the box), whether it is played automatically, and even content within the video. This capability allows customers to make more informed decisions.

The crawling and rendering can be performed in advance to build a database of video and other content metadata, but information can also be derived in real time as the impression opportunity is provided to the customer.

A typical workflow can proceed as follows. A URL query, impression beacon, or RTB traffic submits request to the FB from an inventory source. If it is an RTB request, and if the video has previously been analyzed by the crawler, the metadata is retrieved from the index, and an appropriate bid is returned based on criteria established by the customer. The impression is logged into the index, along with additional data items submitted in request.

If the URL is new or if a previous record is out of date, the URL is submitted to the RC, and a modified web browser is sent to the page to extract content information. The third party APIs are queried for additional information about the URL. The client URL or video has tagging rules executed and the records are updated based on results. The index data is tagged for white listing and priority buying.

For agencies that work with customers, trading desks, and other customer-side users, the system can allow them to create video channels to match a customer's need, including video-level categorization, content attributions, and situational relevance, and allow them to set criteria including content (such as video) player location within a page (e.g., above the fold or below the fold, indicating whether a user needs to scroll to get to the video), player size, player type, whether auto-play is implemented or click-to-play, what content is adjacent to the video, type of browser (e.g., mobile versus desktop type of browser), ambient video advertising, number and size of frames, et al. This system can thus assist with ad buys by demographics and geographic factors, around viral sharing, directed to mobile devices, and use via television.

While the focus above has mainly been on customers who are purchasers of advertising opportunities, the system can also be used for content providers, such as a publishers or a supply-side platforms. The system can allow the publisher to scan and tag its content before that content enters an exchange where it will be bid on, and this can provide information to advertising bidders/buyers that may be relevant, such as confirming the size of the video, whether it is click-to-play, what content is adjacent, and other information that might not otherwise be generally available. This process can be performed in an automated manner, such that the content is checked for certain parameters. This allows a publisher to provide premium content be performing automated processing on its content inventory.

The extendible bidding platform has all of the functional parts of a typical bidding system, and allows bidding on one or more ad exchanges, and allows advertisers to use complex decision rules for ad targeting that involve some level of inference (logical or heuristic) on Bid Request attributes provided by the exchange; or complex decision rules involving some level of inference on Bid request attributes alone or in combination with other data specified and provided by the advertiser, or a third party, and is synchronized manually with the bidder; or complex decision rules involving some level of inference on Bid Request attributes alone or in combination with other data specified and provided by the advertiser, or a third party, and residing on a system that is remote to the bidding platform and may be automatically synchronized by the Bidding platform.

Advertisers can use Ad Servers to customize, define, and/or implement new Bid Request attributes that can subsequently be used for targeting by the advertiser. This can be accomplished through the use of a formal language for describing complex decision rules understood by the bidding system, and/or through the use of a web-console user interface. The Advertisers can define remote or hosted databases used to augment Bid Request attributes, and can subsequently be used for targeting by the advertiser through the use of a formal language for describing complex decision rules understood by the bidding system, and/or through the use of a web-console user interface.

Advertisers can implement, modify, and deploy features to the platform for their own use or the use of other users of the platform by defining data sources, inference rules, or attributes, or providing a platform with source code that may or may not be tracked, compiled and executed by the platform to extend its functionality to the advertiser; providing the platform with a user interface widget written in an appropriate markup language that exposes features or capabilities of the platform to the advertiser through the platform's user interface.

The content indexing and targeting system for RTB can monitor and log Ad Exchange bid requests to generate useful statistics or metadata to be use in inventory forecasting or RTB ad targeting, and incorporate data other than that provided explicitly by the Ad Exchange (i.e., perform off-line data collection). This system can track unique URLs and partial URLs supplied to it by the Ad Exchange, and operate a crawling system to automatically visit URLs, collect metadata, and generate classifications about the URLs or that will directly or indirectly used to target ad impressions in an RTB environment. The system stores and manages the data generated by the crawling system so that it is available to the Bidder in RTB operating conditions, when deciding to respond to a bid request. The system can be customized by advertisers with their own source code. The system can use a multitude of different crawlers to collect different kinds of data, where individual crawlers are managed by a controller that coordinates the collection of information across URLs and merges the results of the different crawlers into a single record for the URL.

The index includes a collection of servers and storage devices constituting a database that is capable of supporting RTB operating requirements, and is capable of resolving remote data sources and maintaining a local cache; synchronizing with remote data sources and sending alerts to dependent systems when the remote datasource is modified, and transparently calculating, storing and managing content-based signatures of its entries so as to provide rapid responses to complex decision rules while satisfying the requirements of RTB operating conditions. The system can handle dynamic schema updates, and dynamically load advertiser-supplied object libraries or other compiled code to extend its indexing or data access capabilities. The index can automatically generate schemas and other database configurations it can understand by parsing source code and/or schemas written in other languages.

The RTB system can use cryptocurrency protocols to track budgets and RTB spending across machines and bidders. The RTB system can infer demographic information based on geolocation information provided in the Bid Request.

The system is generally implemented in hardware and software as various forms of logic, which may be soft or hard. Various types of processors can be used, including microprocessors, groups of microprocessors, ASICs, DSPs, microcontrollers, or any other special or general purpose hardware that can execute instructions. Instructions can be stored in non-transient form in memory, which can include solid state, magnetic, optical, or other suitable forms of memory. The system components include interfaces that operate with the websites, servers, network, and platforms identified in the figure(s) above through communications interfaces that provide wired or wireless communications, including, as needed transmitters, receivers, RF circuitry, network interfaces, and other forms of hardware and software for interfacing components.

In one more specific implementation, the system uses a MySQL cluster of MySQL servers with connections to multiple database nodes, with geographic replication.

What is claimed is:

1. A real-time bidding (RTB) system for use with an ad exchange that causes to be provided to end users advertising with content for display to the end user, the system comprising:
an RTB bidder having an interface to an ad exchange for receiving a bid request to bid on the display of advertising, the bidder responsive to information relating to an end user, responsive to content attributes from an ad exchange relating to the content, the bidder for generating a query based on the user information and content attributes; and
a directory server, responsive to the query, for providing the query to one or more databases to obtain bidding information based on the information relating to the end user and content attributes;
the bidder for using the response to the bidding information, for determining how much to bid based on the bidding information.

2. The RTB system of claim 1, wherein the RTB bidder is responsive to rules received from a customer requiring inferences.

3. The RTB system of claim 1, wherein the bidder and directory server are configured to provide a bid within less than 100 msec.

4. The RTB system of claim 1, further comprising a database for storing URLs of bid requests.

5. A real-time bidding (RTB) system comprising:
a database of metadata regarding online content that gets displayed to users, the metadata including uniform resource locators (URLs);
a crawler system including a plurality of types of crawlers with different capabilities, the crawlers identifying online content and determining which of the plurality of crawlers to use to extract information about the content for storage in the database.

6. The system of claim 5, wherein the crawlers include a plaintext crawler for obtaining content of arbitrary URLs, identifying a format of the data, parsing the content, and causing data about the content to be stored in the database.

7. The system of claim 5, further comprising a JavaScript crawler for HTML pages, the JavaScript crawler for parsing and loading a page in a virtual web browser for analysis.

8. The system of claim 5, further comprising a rendering crawler for obtaining screenshots, flash content, and relative locations of elements on a webpage using a virtual browser for rendering the page to memory.

9. The system of claim 5, further comprising a browser-specific rendering crawler that determines browser-specific content or behavior of a page.

10. The system of claim 9, wherein the browser-specific rendering crawler is configured to determine differences between content loading on a mobile browser versus a desktop browser.

11. The system of claim 5, wherein the crawlers include a plaintext crawler that operates on a URL, performs indexing, the system determining whether the content should be provided to a second crawler that includes a virtual browser for rendering.

12. A system comprising:
a database; and
a web crawler configured to visit a website, performing a virtual rendering of a video on the website, identify characteristics of the video as rendered, and storing in the database metadata relating to the characteristics of the video.

13. The system of claim 12, wherein the characteristics include one or more of: determining the size of the video as played, determining whether the video plays automatically or with a click, and information about content in the video.

14. The system of claim 12, wherein the database is responsive to bid requests received over time from one or more ad exchanges.

15. A real-time bidding (RTB) method for use with an ad exchange that causes to be provided to end users advertising with content for display to the end user, the system comprising:
receiving a bid request to bid on the display of advertising, generating a query based on user information and content attributes;
providing the query to a directory server;
the directory server responsive to the query, for providing the query to one or more third party databases to obtain bidding information based on the information relating to the end user and content attributes;
using the response to the bidding information, for determining how much to bid based on the bidding information.
